(19) United States
(12) Patent Application Publication
(10) Pub. No.: US 2008/0230474 A1
(43) Pub. Date: Sep. 25, 2008

(54) System and method for filtering water and/or wastewater

(76) Inventors: R. Lee Roberts, Chadds Ford, PA (US); Mark Kevin Addison, Bear, DE (US)

Correspondence Address: MEREK, BLACKMON & VOORHEES, LLC, 673 South Washington Street, Alexandria, VA, 22314, US

(21) Appl. No.: 11/723,994

(22) Filed: Mar. 23, 2007

(51) Int. Cl. C02F 1/44; B01D 36/02

(52) U.S. Cl. 210/641; 210/335

(57) ABSTRACT

A filter system for filtering water and/or wastewater that includes a roughing filter followed by a polishing filter where the roughing filter is an upflow filter and the polishing filter is a membrane filter. The upflow filter includes a filter bed formed from one or more layers of media. The media may be naturally occurring or plastic. Further, the media may be buoyant or non-buoyant. Preferably, the filter system is formed as a package unit. The upflow filter and membrane filter may share a common base allowing the filter system to be readily transported as a single unit. Alternatively, the membrane filter may be connected to and supported by a vertical wall of the upflow filter. The membrane filter may include membrane filter modules that are housed as a group in a section of the membrane filter or the membrane filter modules may be individually housed. The washing liquid used in washing the upflow filter may be discharged from the upflow filter through the same conduit as the upflow effluent generated during filtration. Preferably, the upflow waste line is positioned adjacent the membrane filter drain to allow the upflow waste line and the membrane filter drain to direct liquid to the same storage area or unit through at least one common conduit. The water level of the clearwell is preferably positioned a sufficient distance below the water level of the upflow filter to achieve the desired loading rate across the membrane filter without the need for pumping the upflow effluent into the membrane filter.

### FIELD OF THE INVENTION

The present invention is directed to a filter system for filtering water and/or wastewater that includes a roughing filter followed by a polishing filter where the roughing filter is an upflow filter and the polishing filter is a membrane filter.

### BACKGROUND OF THE INVENTION

Numerous filter systems have been developed for filtering water and/or wastewater. For example, U.S. Pat. Nos. 5,080,808; 5,198,124; and 5,314,630 disclose a filter system having an upflow filter followed by a downflow filter. The upflow filter and downflow filter each include a non-buoyant granular media filter bed. The upflow filter is washed with liquid and air where the velocity of the liquid is less than the minimum fluidization velocity of the filter layer in the filter bed where minimum fluidization velocity is determined by the following formula: v_{mf}=0.00381(d_{60%})^{1.82}(sg−1)^{0.94}ρ^{1.88}μ^{-0.88} where “d_{60%}” is the 60% size of the media particles in millimeters (equal to the product of the uniformity coefficient of the particles (UC) and the effective size of the particles (ES)); “sg” is the specific gravity of the particles; “ρ” is the density of the liquid in lbs./cu.ft., and “μ” is the viscosity of the liquid in centipoise.

Another filter system is disclosed in U.S. Pat. No. 4,547,286. This filter system includes a roughing upflow filter employing a buoyant media that necessarily is fluidized during washing. Specifically, due to the fact that the media is buoyant it will always fluidize as that term is defined above. To effectuate washing, air is injected into the washing liquid to cause the buoyant media to descend and remain suspended in the washing liquid. The roughing filter is followed by a downflow polishing filter.

A further filter system employs a two-stage filter system (i.e., roughing filter and polishing filter) in a single compartment. More specifically, a plurality of gravel layers beneath a sand layer are provided in a single upflow compartment. The gravel layers are the roughing filter while the sand layer is the polishing filter.

There are numerous other filters including but not limited to modular filters, bi-flow filters and membrane filters. Membrane filters are typically classified by the size of the membrane opening or the minimum size of the particles that can be removed. Common classifications ranging from coarse to fine are microfiltration, ultrafiltration, nanofiltration and reverse osmosis. These membrane filters are capable of removing very fine particles down to the molecular level, depending up classification of the filter. There are a number of different configurations for membrane filters, including but not limited to, dead end filtration, cross-flow filtration, hollow fiber membranes, spiral wound membranes and sheet type membranes. However, membrane filters tend to be prone to clogging or fouling and often require pretreatment depending upon the particular application. Membrane filters also typically require high driving pressures compared to conventional granular media filtration in order to achieve reasonable loading rates (or flux) across the membrane. Large pore membranes as well as other membrane technology have been recently developed, thus minimizing some of the aforementioned disadvantages of membrane filters.

### OBJECTS AND SUMMARY OF THE INVENTION

An object of a preferred embodiment of the present invention is to provide a novel and unobvious filter system for filtering water and/or wastewater.

Another object of a preferred embodiment of the present invention is to provide a filter system that provides superior pretreatment for a membrane filter.

A further object of a preferred embodiment of the present invention is to provide a filter system that has a reduced footprint and yet is still suitable for a wide variety of applications.

Yet still a further object of a preferred embodiment of the present invention is to provide a filter system that is more cost effective than prior art designs.

Still another object of a preferred embodiment of the present invention is to provide a filter system that is a package plant having an upflow type roughing filter followed by a membrane type polishing filter that can be readily assembled and shipped to the installation site.

Still a further object of a preferred embodiment of the present invention is to provide a filtration system having an upflow type roughing filter followed by a membrane type polishing filter that does not require pumps and can be retrofitted into an existing water or wastewater filtration system.

Yet another object of a preferred embodiment of the present invention is to provide a filtration system having an upflow type roughing filter followed by a membrane type polishing filter where the upflow filter is a pressure filter to eliminate the need to re-pump the liquid to be filtered through the membrane type polishing filter.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one embodiment of the present invention is directed to a method for clarifying a liquid including the steps of: (a) providing an upflow filter having a filter bed including at least one layer of filter media; (b) providing a membrane filter having a plurality of membrane filter modules; and, (c) connecting the upflow filter and the membrane filter such that the upflow filter is a roughing filter and the membrane filter is a polishing filter so that liquid filtered by the upflow filter is directed to the membrane filter for further filtration.

Another embodiment of the present invention is directed to a system for clarifyng a liquid. The system includes an upflow filter having a filter bed including at least one layer of filter media and a membrane filter having a plurality of membrane filter modules. The membrane filter is operably connected to the upflow filter such that the upflow filter is a roughing filter and the membrane filter is a polishing filter so that liquid filtered by the upflow filter is directed to the membrane filter for further filtration.

A further embodiment of the present invention is directed to a system for clarifying a liquid. The system includes an upflow filter having a filter bed. The filter bed has at least one layer of filter media. The system further includes a membrane filter having a first section and a second section. The first section forms a chamber for receiving a liquid filtered by the upflow filter from an upflow filter effluent conduit. The second section includes a plurality of membrane filter modules. The chamber of the first section is free from membrane filter modules. The chamber further is operably connected to the second section to direct a liquid filtered by the upflow filter to the second section of the membrane filter for further filtration. The first section of the membrane filter is disposed between the filter bed of the upflow filter and the second section of the membrane filter.

### BRIEF DESCRIPTION OF THE DRAWINGS

FIG. 1 is an elevation view of a filter system formed in accordance with a preferred embodiment of the present invention.

FIG. 2 is a plan view of the filter system depicted in FIG. 1.

FIG. 3 is a plan view of an alternative piping arrangement for the filter system depicted in FIG. 1.

FIG. 4 is an elevation view of a filter system formed in accordance with a second preferred embodiment of the present invention.

FIG. 5 is a plan view of the filter system depicted in FIG. 4.

FIG. 6 is a view take along lines A-A in FIG. 4.

FIG. 7 is a view take along lines B-B in FIG. 4.

### DETAILED DESCRIPTION OF THE PREFERRED EMBODIMENTS OF THE INVENTION

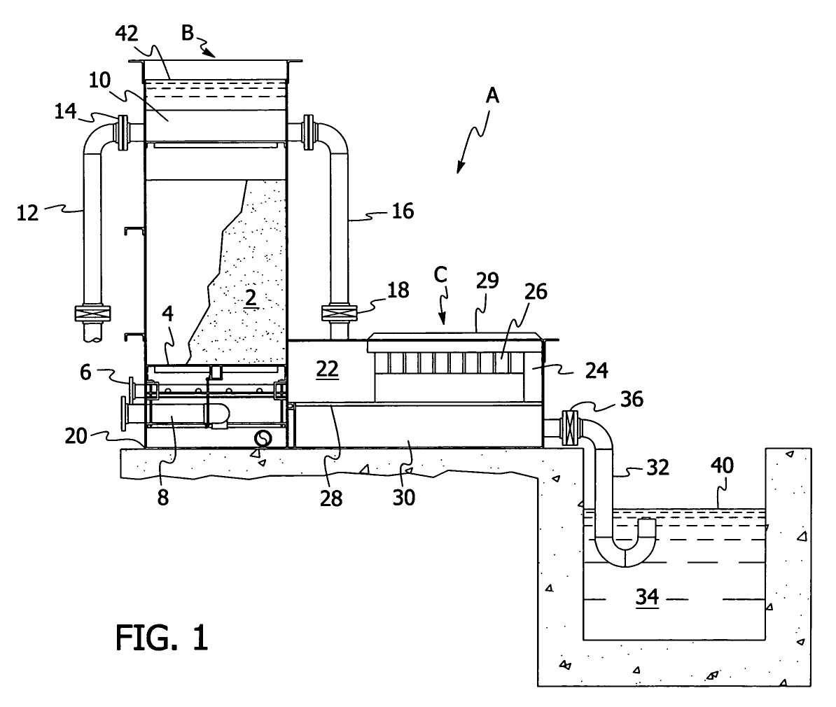

The preferred forms of the invention will now be described with reference to FIGS. 1 to 7. The appended claims are not limited to the preferred forms and no term and/or phrase used herein is to be given a meaning other than its ordinary meaning unless it is expressly stated otherwise.

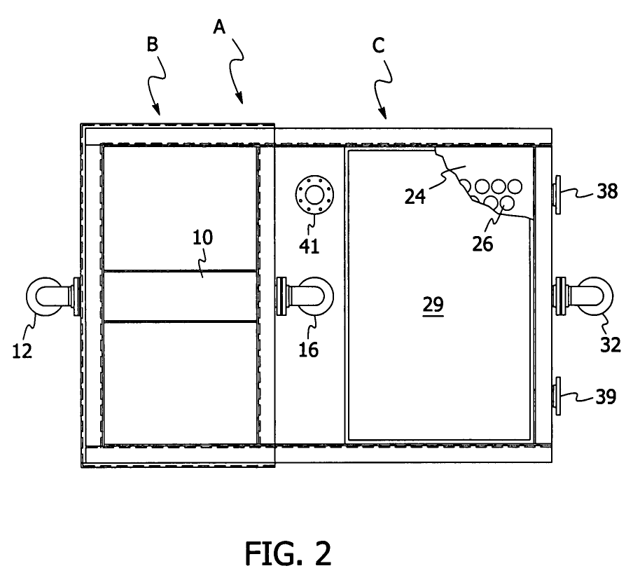

### FIGS. 1 and 2

Referring to FIGS. 1 and 2, filter system A formed in accordance with a preferred embodiment of the present invention is illustrated. Filter system A includes a roughing filter B having a filter bed 2 with at least one layer of filter media supported by a retaining screen 4. The at least one layer of filter media can be formed in the same manner as the filter layer for the upflow filter described in U.S. Pat. Nos. 5,080,808; 5,198,124; and, 5,314,630. The filter bed 2 can also include a transitional layer and a flocculation layer of the type described in U.S. Pat. Nos. 5,080,808; 5,198,124; and, 5,314,630. Alternatively, the filter bed 2 can be formed from a plastic, buoyant media in the same manner as the upflow filter described in U.S. Pat. No. 4,547,286. These are just two examples of filter beds. The present invention is not limited to these two types of filter beds. Rather, any suitable filter bed can be used. Upflow filter B may also be a pressure filter.

Beneath the filter bed 2 is an air distributor 6 and an influent distributor 8. Air distributor 6 is connected to a source of air while influent distributor 8 is connected to the source of water or wastewater to be filtered. During filtration, influent is directed upwardly through filter bed 2 from influent distributor 8 and collected in trough 10. Coagulants, oxidants, pH adjusting chemicals, polymers and/or other chemical additions commonly used in water filtration may be added to the influent prior to entry into filter bed 2. Enhanced coagulation may also be used. As influent is passed upwardly through filter bed 2, a significant amount of impurities are removed from the influent by the filter bed 2. During washing of the filter bed 2 to remove impurities trapped therein during filtration, air conduit 6 directs air upwardly through filter bed 2. Air may be directed during only a portion of the washing procedure. For example, where the filter bed 2 is formed from one or more layers as described in U.S. Pat. Nos. 5,080,808; 5,198,124; and, 5,314,630, the filter bed 2 may be washed in the two-stage manner described in U.S. Pat. Nos. 5,080,808; 5,198,124, and, 5,314,630, i.e., liquid and air followed by liquid alone at the rates and time periods specified therein. The washing liquid may be the influent or filtered water. Alternatively, air may be directed upwardly through the filter bed 2 during the entire washing period. For example, where the filter bed 2 of upflow filter B is formed as described in U.S. Pat. No. 4,547,286, the filter bed 2 can be washed in the manner described in U.S. Pat. No. 4,547,286. However, it should be noted that the present invention is not limited to the washing procedures described in U.S. Pat. Nos. 5,080,808; 5,198,124; 5,314,630 and 4,547,286. Rather, any suitable washing procedure may be utilized.

Trough 10 is connected at one end to waste line 12 and at the other end to the membrane influent line 16. Valve 14 controls the flow of liquid through waste line 12. Specifically, when valve 14 is open (i.e., during the washing procedure), liquid collected in trough 10 passes through waste line 12. When valve 14 is closed (i.e., during filtration), liquid collected in trough 10 is directed to membrane influent line 16. Valve 18 controls the flow of liquid from the membrane influent line 16 to the membrane filter C. When valve 18 is open, liquid passes into the membrane filter C for further filtration. Chemicals feeds, static mixers, flow meters, and other appurtenances which may be present are not shown for clarity. Clean in place cleaning systems and membrane integrity test systems which may be present are also not shown.

Membrane filter C and the upflow filter B are mounted on common base 20. Preferably, base 20 is a flat plate of sheet metal or other suitable material. The base may also take the form of a skid having channels or other means to allow the unit to be readily transported. However, it will be readily appreciated that the base may be configured as desired. Preferably, the base is such that the filter system A including the upflow filter B and the membrane filter C can be readily transported together as a single unit. Filter system A is preferably formed as a packaged unit, i.e., the filter system A is assembled at one location and shipped as a unit to the installation site.

Membrane filter C includes a first section 22 into which liquid filtered by upflow filter B is directed. First section 22 is in fluid communication with second section 24 housing a plurality of membrane modules 26. Membrane modules 26 can be formed in the manner described in U.S. Pat. No. 6,890,436. Alternatively, membrane modules 26 can take the form of the hollow fiber Kuraray Co. Ltd. CE-330 LP-MF element. It should be noted that these are two of many possible configurations for membrane modules 26. The present invention is not limited to these two forms of membrane modules. Rather, membrane module 26 can be formed in any suitable manner. Membrane modules 26 preferably include large pore membranes with a nominal pore size of approximately 2.0 μm. However, the pore size can be varied as desired. Referring to FIG. 2, second section 24 includes a removable cover 29 which allows ready access to membrane modules 26. Alternatively, membrane filter C may take the form of an atmospheric tank with one or more membrane cassettes stored in the tank to filter the effluent from the upflow filter B. Atmospheric tank membrane filters having cassettes are manufactured by U.S. Filter and Zenon Environmental, Inc.

Partition 28 separates first section 22 and second section 24 from plenum 30. Membrane filter C is configured such that liquid passes through first section 22 into second section 24 where the liquid is further filtered by membrane modules 26. More specifically, the liquid travels through the membrane modules 26 and impurities in the liquid are removed by the large pore membranes. Membrane modules 26 are in fluid communication with plenum 30 such that the liquid filtered by a particular membrane module 26 travels downwardly into plenum 30.

Membrane effluent conduit 32 is connected at one end to plenum 30 while the other end empties into clearwell 34. Valve 36 controls the flow of effluent through conduit 32, i.e., when valve 36 is open effluent from membrane filter C is directed into clearwell 34. Referring to FIG. 2, membrane filter C includes a filter drain 38. Flow of liquid through filter drain 38 is controlled by a valve not shown. When membrane filter is filtering liquid, the filter drain valve is closed to prevent liquid from draining through filter drain 38. When membrane filter C is to be washed, valves 18 and 36 are closed. Referring to FIG. 2, membrane filter C includes a membrane air backwash inlet 39 through which air is directed into second section 24 and through membrane modules 26 to remove the impurities trapped in the membranes during filtration. Membrane filter C further includes a membrane air backwash outlet 41 through which the washing air exits. After backwashing, the filter drain vale is opened to allow all liquids and contaminants contained in membrane filter C to drain through filter drain 38 followed by an optional rinse step where the influent to the membranes is introduced into compartments 22 and 24 and then out through drain 38. The compartments 22 and 24 are then refilled with influent and returned to service. The present invention is not limited to an air only backwash of the membrane filter portion of the system. Rather, any suitable method of washing the member filter portion of the system can be used.

Preferably, clearwell 34 is positioned such that the water level 40 of the clearwell is three to five meters below the water level 42 in the upflow filter B. This arrangement creates the necessary driving head to direct liquid at the desired loading rates through membrane filter C without the need for a pump to pump the liquid flowing from upflow filter B to membrane filter C. Where the upflow filter B is a pressure filter, it is not necessary to locate the water level of the clearwell 34 three to five meters below the water level of upflow filter B.

Filter system A may include means for priming conduit 32. Additionally, filter system A may include a sensor for sensing loss of prime in conduit 32.

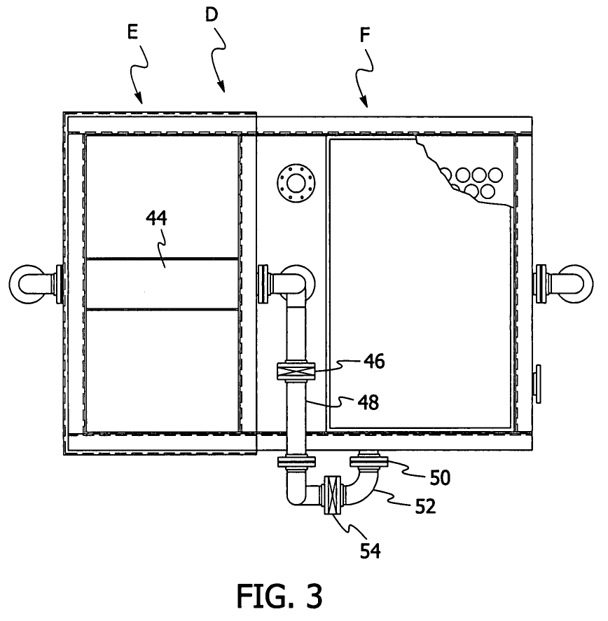

### FIG. 3

Filter system D depicted in FIG. 3 is similar to filter system A and, therefore, only the differences will be described in detail. Filter system D directs both the washing liquid washing upflow filter E and the liquid to be further filtered by membrane filter F out the right side of trough 44 as viewed in FIG. 3. In other words, filter system D omits the separate waste line 12 used in filter system A. Valve 46 is provided to control the flow of liquid through clarifier waste conduit 48, i.e., when valve 46 is open, fluid travels through clarifier waste conduit 48 and is directed to a waste storage unit or area. Valve 46 is open during washing of upflow filter E. During filtration, valve 46 is closed and a valve (not shown) on the membrane filter influent conduit is opened allowing liquid filtered by upflow filter E to be directed into membrane filter F for further filtration. Preferably, membrane filter drain 50 is disposed directly adjacent clarifier waste conduit 48. Conduit 52 connects filter drain 50 to clarifier waste conduit 48 so that the washing liquid from upflow filter E and liquid from membrane filter F may be directed to the same storage area or unit through at least one common conduit. A valve 54 controls the draining of liquid from the membrane filter F. Specifically, when upflow filter E is being washed, valve 54 is closed preventing liquid in membrane filter F from draining. When valve 46 is closed (i.e., when upflow filter E is not being washed), valve 54 can be opened to drain liquids from membrane filter C.

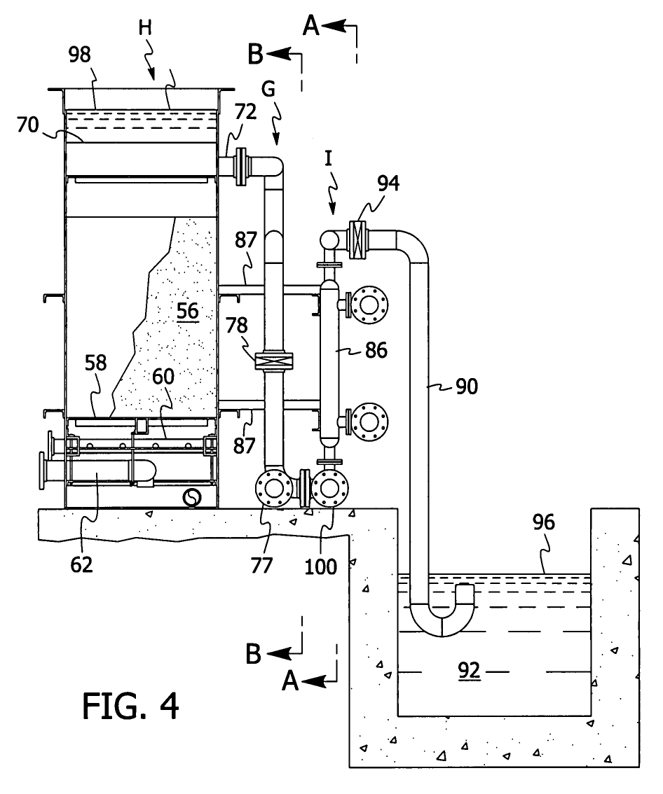

### FIGS. 4 to 7

Referring to FIGS. 4 to 7, filter system G formed in accordance with another preferred embodiment of the present invention is illustrated. Filter system G includes a roughing filter H having a filter bed 56 with at least one layer of filter media supported by a retaining screen 58. The at least one layer of filter media can be formed in the same manner as the filter layer for the upflow filter described in U.S. Pat. Nos. 5,080,808; 5,198,124; and, 5,314,630. The filter bed 56 can also include a transitional layer and a flocculation layer of the type described in U.S. Pat. Nos. 5,080,808; 5,198,124; and, 5,314,630. Alternatively, the filter bed 56 can be formed from a plastic, buoyant media in the same manner as the upflow filter described in U.S. Pat. No. 4,547,286. These are just two examples of filter beds. The present invention is not limited to these two types of filter beds. Rather, any suitable filter bed can be used. Upflow filter H may also be a pressure filter.

Beneath the filter bed 56 is an air distributor 60 and an influent distributor 62. Air distributor 60 is connected to a source of air while influent distributor 62 is connected to the source of water or wastewater to be filtered. During filtration, influent is directed upwardly through filter bed 56 from the influent distributor 62 and collected in trough 70. Coagulants, oxidants, pH adjusting chemicals, polymers and/or other chemical additions commonly used in water filtration may be added to the influent prior to entry into filter bed 56. Enhanced coagulation may also be used. As influent is passed upwardly through the filter bed 56, a significant amount of impurities are removed from the influent by the filter bed 56. During washing of the filter bed 56, the air conduit 60 directs air upwardly through the filter bed 56. Air may be directed upwardly through filter bed 56 during only a portion of the washing procedure. For example, where the filter bed 56 is formed from one or more layers as described in U.S. Pat. Nos. 5,080,808; 5,198,124; and, 5,314,630, filter bed 56 may be washed in the two-stage manner described in U.S. Pat. Nos. 5,080,808; 5,198,124, and, 5,314,630 i.e., liquid and air followed by liquid alone at the rates and time periods specified therein. The washing liquid may be the influent or filtered water. Alternatively, air may directed upwardly through the filter bed 56 during the entire washing period. For example, where filter bed 56 of upflow filter B is formed as described in U.S. Pat. No. 4,547,286, filter bed 56 can be washed in the manner described in U.S. Pat. No. 4,547,286. However, it should be noted that the present invention is not limited to the washing procedures described in U.S. Pat. Nos. 5,080,808; 5,198,124; 5,314,630 and 4,547,286.

Trough 70 is connected at one end to conduit 72 through which clarifier waste (i.e., washing liquid during washing of upflow filter H) and clarifier effluent (i.e., liquid filtered by upflow filter H during filtration) both pass. Filter system G also omits the separate clarifier waste line 12 of filter system A.

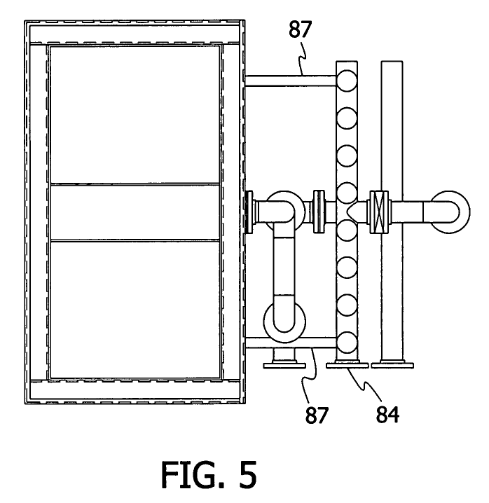

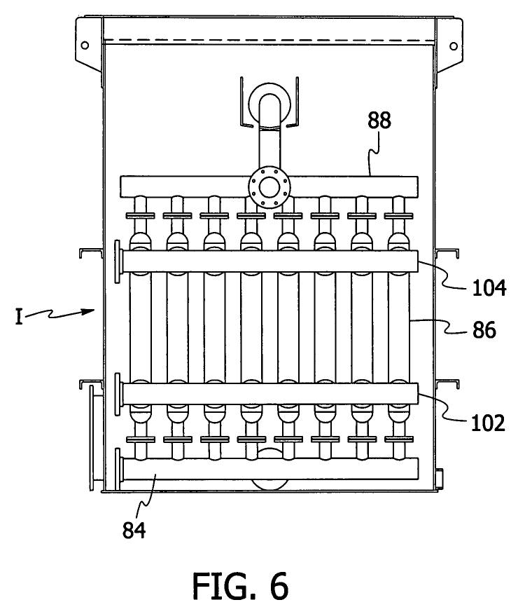

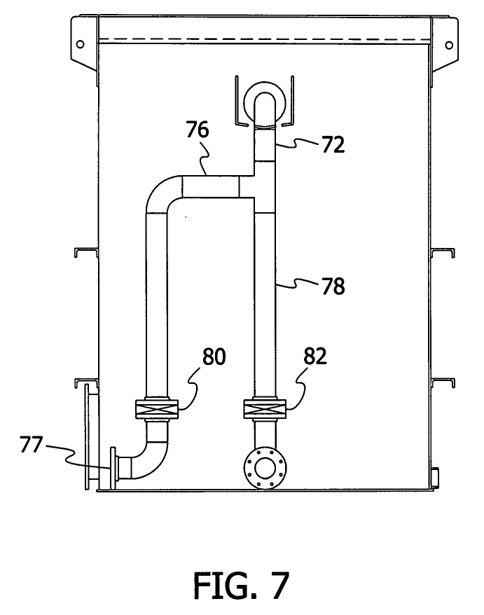

Referring to FIG. 7, conduit 72 is connected to conduit 76 and conduit 78. When valve 80 is open (i.e., during washing of upflow filter H), washing liquid from upflow filter H is directed through conduit 76, out upflow filter waste outlet 77 and into a waste storage unit or area. When valve 82 is open and valve 80 is closed (i.e., during the filtration stage), conduit 78 directs upflow filter effluent to header 84 of the membrane filter I. Header 84 serves to direct the upflow clarifier effluent into each of the individually housed membrane filter modules 86 of membrane filter I as shown in FIG. 6. The membrane filter modules 86 may be formed in a manner similar to membrane filter modules 26. Header 88 of membrane filter I receives the effluent flowing upwardly from each of the membrane filter modules 86. Preferably, membrane filter I including header 84, individually housed membrane filter modules 86 and header 88 are supported by upflow filter H via brackets 87 (preferably four brackets, two upper and two lower) connected to and extending outwardly from upflow filter H as shown in FIGS. 4 and 5. This arrangement allows the filter system to be assembled by the manufacturer and subsequently transported to the installation site as a package unit.

Referring to FIG. 4, conduit 90 connects header 88 to clearwell 92. Valve 94 controls the flow of membrane filter effluent through conduit 90, i.e., when valve 94 is open during filtration effluent from the membrane filter I flows into clearwell 92.

Preferably, clearwell 92 is positioned such that the water level 96 of clearwell 92 is three to five meters below the water level 98 in the upflow filter H. This arrangement creates the necessary driving head to direct liquid through membrane filter I without the need for a pump to pump the liquid flowing from upflow filter H to membrane filter I. Where the upflow filter H is a pressure filter, it is not necessary to locate the water level of the clearwell three to five meters below the water level of upflow filter H.

Header 84 includes a membrane filter drain outlet 100 located directly adjacent upflow filter waste outlet 77. Drain outlet 100 and waste outlet 77 are connected in a similar manner to conduits 48 and 50 in FIG. 3. Hence, when a valve similar to valve 54 illustrated in FIG. 3 is open and valves 80 and 82 are closed, liquid from the membrane filter I can be drained to the same waste storage unit or area as the washing liquid from upflow filter H through at least one common conduit. Referring to FIG. 6, membrane filter I includes an air inlet header 102 supported by and connected to each of the individually housed membrane filter modules 86. Air header 102 directs air from an air source upwardly through each of the individually housed membrane filter modules 86 to clean the membranes in each of membrane modules 86. Air is used to clean modules 86. Membrane filter I includes an air outlet header 104 supported by and connected to each of the individually housed membrane filter modules 86. Air passing upwardly through each of membrane modules 86 exits through air header outlet 104. After the air backwash, the membrane modules 86 are drained, optionally rinsed, refilled, and returned to service, i.e., filtration mode. It should be noted that each individual membrane module 86 may be individually backwashed. In this instance, a valve could be placed between air header 102 and each membrane module 86 to isolate each membrane module 86 to permit air to be selectively directed to one or more membrane modules 86 to be washed at a given time by merely opening one or more of the corresponding valves. The membrane modules 86 not being washed with air can still be run in filtration mode. This maximizes the efficiency of the filter system.

Filter system G may include means for priming conduit 90. Additionally, filter system G may include a sensor for sensing loss of prime in conduit 90.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

We claim:

1. A method for clarifyng a liquid, said method including the steps of:
(a) providing an upflow filter having a filter bed including at least one layer of filter media;
(b) providing a membrane filter having a plurality of membrane filter modules; and,
(c) connecting the upflow filter and the membrane filter such that the upflow filter is a roughing filter and the membrane filter is a polishing filter so that liquid filtered by the upflow filter is directed to the membrane filter for further filtration.

2. A method, as recited in claim 1, further including the step of:
(a) assembling the upflow filter and membrane filter as a package unit.

3. A method, as recited in claim 2, further including the step of:
(a) shipping the package unit to an installation site after said step (a) in claim 2.

4. A method, as recited in claim 3, wherein:
(a) said step (a) in claim 2 includes providing the upflow filter and the membrane filter with a common floor or skid so that the package unit can be readily transported to an installation site.

5. A method, as recited in claim 3, wherein:
(a) said step (a) of claim 2 includes supporting the membrane filter from a substantially vertically extending wall of the upflow filter.

6. A method, as recited in claim 1, further including the step of:
(a) directing influent upwardly through the filter bed of the upflow filter and subsequently downward into the membrane filter.

7. A method, as recited in claim 1, further including the step of:
(a) forming the filter bed of the upflow filter from a buoyant media.

8. A method, as recited in Claim l, further including the step of:
(a) forming the filter bed of the upflow filter from a non-buoyant media.

9. A system for clarifying a liquid, said system comprising:
(a) an upflow filter having a filter bed including at least one layer of filter media; and,
(b) a membrane filter having a plurality of membrane filter modules, said membrane filter being operably connected to said upflow filter such that said upflow filter is a roughing filter and said membrane filter is a polishing filter so that liquid filtered by said upflow filter is directed to said membrane filter for further filtration.

10. A system as set forth in claim 9, wherein:
(a) said upflow filter includes a liquid collection member and a pipe operably connected to said liquid collection member, said liquid collection member is disposed above said filter bed, said upflow filter is configured such that a liquid filtered by said upflow filter and a waste washing liquid flowing from said upflow filter travel through said liquid collection member and said pipe.

11. A system as set forth in claim 10, wherein:
(a) said liquid collection member is a trough.

12. A system as set forth in claim 9, wherein:
(a) said upflow filter includes a liquid collection member, a first pipe and a second pipe, said first pipe is operably associated with a first end of said liquid collection member to carry away a waste liquid from said liquid collection member, said second pipe is operably associated with a second end of said liquid collection member to convey a liquid filtered by said upflow filter to said membrane filter, said first end of said liquid collection member is disposed opposite said second end of said liquid collection member.

13. A system as set forth in claim 9, wherein:
(a) said upflow filter includes a waste washing liquid outlet through which a waste washing liquid passes;
(b) said membrane filter includes a filter drain for draining said membrane filter of liquids; and,
(c) said waste washing liquid outlet is disposed intermediate said filter bed of said upflow filter and said plurality of membrane filter modules.

14. A system as set forth in claim 13, further including:
(a) a connector for connecting said waste washing liquid outlet and said filter drain thereby permitting said waste washing liquid outlet and said filter drain to direct liquids to a single waste collection region.

15. A system as set forth in claim 14, wherein:
(a) said connector includes at least one valve for controlling flow of liquid to said single waste collection region.

16. A system as set forth in claim 15, wherein:
(a) said at least one valve includes at least an open condition where liquid is free to drain from said membrane filter and a closed condition where liquid cannot be drained from said membrane filter through said valve.

17. A system as set forth in claim 9, wherein:
(a) said upflow filter includes at least one substantially vertically extending wall, said membrane filter is supported by said at least one substantially vertically extending wall.

18. A system for clarifyng a liquid, said system comprising:
(a) an upflow filter having a filter bed including at least one layer of filter media; and,
(b) a membrane filter having a first section and a second section, said first section forming a chamber for receiving a liquid filtered by said upflow filter from an upflow filter effluent conduit, said second section including a plurality of membrane filter modules, said chamber of said first section being free from membrane filter modules, said chamber further being operably connected to said second section to direct a liquid filtered by said upflow filter to said second section of said membrane filter for further filtration, said first section of said membrane filter being disposed between said filter bed of said upflow filter and said second section of said membrane filter.

19. A system as set forth in claim 18, wherein:
(a) said chamber includes a gas outlet for permitting escape of a gas used to wash said plurality of membrane filter modules.

20. A system as set forth in claim 18, wherein:
(a) said membrane filter includes a plenum chamber that is disposed below said first section and said second section of said membrane filter, said plenum chamber extends substantially the length of said first section and said second section.

21. A system as set forth in claim 18, wherein:
(a) said upflow filter is a pressurized filter.

22. A system as set forth in claim 18, further including:
(a) a clearwell for receiving effluent from said membrane filter, said clearwell being disposed at an elevation relative to said upflow filter to provide a differential pressure ranging from approximately three meters to approximately five meters at a given flux.

23. A system as set forth in claim 22, wherein:
(a) said plurality of membrane filter modules have large pore membranes.

24. A system as set forth in claim 18, wherein:
(a) at least a portion of said first section of said membrane filter is disposed below a bottommost portion of said filter bed.
